(19) United States
(12) Patent Application Publication
(10) Pub. No.: US 2019/0000710 A1
(43) Pub. Date: Jan. 3, 2019

(54) Thoracic Spine Mobilization/ Manipulation Practitioner Support Tool

(71) Applicant: Brad G. Simpson, Portland, OR (US)

(72) Inventor: Brad G. Simpson, Portland, OR (US)

(21) Appl. No.: 16/022,483

(22) Filed: Jun. 28, 2018

Related U.S. Application Data
(60) Provisional application No. 62/525,874, filed on Jun. 28, 2017.
(60) Provisional application No. 62/539,292, filed on Jul. 31, 2017.

(51) Int. Cl. A61H 15/00; A61H 7/00

(52) U.S. Cl. CPC A61H 15/0092; A61H 2201/1638; A61H 7/001

(57) ABSTRACT

A thoracic manipulation tool for protecting the hands of a practitioner consists of a first distal phalanx-receiving slot, a second distal phalanx-receiving slot, and a third distal phalanx-receiving slot that are positioned along an inner surface of a gripping device. An elongated structural body of the gripping device ensures that an outer surface of the gripping device is pressed against the palm of the practitioner when the manipulation tool is in use. More specifically, when the distal phalanx of the middle finger, the ring finger, and the pinky finger are pressed against the inner surface, the outer surface is pressed against the palm of the user. The materialistic properties of the gripping device ensure that the practitioner can maintain a firm grip while executing the thoracic spine manipulation procedure.

The current application claims a priority to the U.S. Provisional Patent application Ser. No. 62/525,874 filed on Jun. 28, 2017 and a priority to the U.S. Provisional Patent application Ser. No. 62/539,292 filed on Jul. 31, 2017.

### FIELD OF THE INVENTION

The present invention relates generally to hand-tools, support tools, and thoracic spine mobilization and manipulation tools. More specifically, the present invention relates to hand-held thoracic spine mobilization/manipulation practitioner support tools.

### BACKGROUND OF THE INVENTION

Thoracic spine mobilization techniques and thoracic spine manipulation techniques often require practitioners (i.e. physical therapists, chiropractors, osteopaths, among others) to perform manipulation and mobilization techniques using their hands to apply some amount of pressure onto the body of the patient. Utilizing the hands to perform the thoracic spine mobilization/manipulation techniques causes great stress on the hands and joints of the practitioner. The stress causes practitioners to complain of pain, discomfort, and arthritic changes may occur to their digits over time due to the repetitive thoracic manipulations/mobilizations performed. To alleviate some of the stress and to provide some support to the hands and fingers, practitioners commonly grip an object into the third, fourth, and fifth distal interphalangeal joints prior to performing the thoracic spine manipulation/mobilization technique in order to protect the finger joints from the stress caused by the techniques. Some objects used by the practitioners are rolled-up tissues, small rolled-up towels, chap-sticks or batteries. Unfortunately, the finger flexor muscles are not in a good mechanical advantage position to hold the fingers in full flexion during the completion of the manipulation. As a result, greater stress is applied to the finger joints as the joints are not protected during the techniques. Performing thoracic spine techniques using such objects repetitively can be more harmful to the practitioner, which results in many practitioners opting to not perform or complete the techniques. Thus, a hand-held thoracic spine mobilization/manipulation practitioner support tool which is placed outside of the distal phalanges and not on the inside of the distal interphalangeal joints of the hand of the practitioner is beneficial and necessary.

An objective of the present invention is to provide a hand-held thoracic spine mobilization/manipulation practitioner support tool which is placed on the outside of the distal interphalangeal joints. A hand-held thoracic spine mobilization/manipulation practitioner support tool which is held on the outside of the distal interphalangeal joints versus an object being gripped in the palmar aspect of the distal interphalangeal joints is beneficial and necessary to allow practitioners to perform thoracic spinal techniques without causing greater stress on the practitioner's hands or finger joints. Another objective of the present invention is to provide a hand-held thoracic spine mobilization/manipulation practitioner support tool which does not obstruct the typical anterior-adjustment thoracic spine technique. The present invention still allows the practitioner to use his/her own hand for the mobilization/manipulation, but with improved support of the interphalangeal joints. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a perspective view of the present invention.

FIG. 2 is a top view of the present invention.

FIG. 3 is a front view of the present invention.

FIG. 4 is an illustration of the present invention being used with the pistol-grip hand position.

### DETAIL DESCRIPTIONS OF THE INVENTION

All illustrations of the drawings are for the purpose of describing selected versions of the present invention and are not intended to limit the scope of the present invention.

The present invention is a hand-held thoracic spine manipulation/mobilization practitioner support tool. The present invention provides a better alternative to the common practice of gripping a random object to support the fingers and hand of the practitioner while performing thoracic spine manipulation/mobilization on a patient.

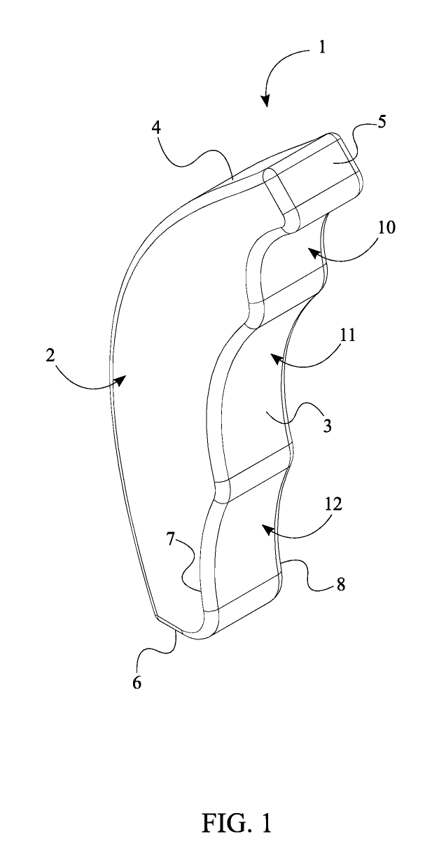

As shown in FIGS. 1-3, to fulfill the intended functionalities, the present invention comprises a gripping device 1, a first distal phalanx-receiving slot 10, a second distal phalanx-receiving slot 11, and a third distal phalanx-receiving slot 12. The gripping device 1 forms the physical body of the present invention. The first distal phalanx-receiving slot 10, the second distal phalanx-receiving slot 11, and the third distal phalanx-receiving slot 12 are used to position the distal phalanx of the middle finger, the ring finger, and the pinky finger, respectively. By doing so, the present invention allows optimal flexion in the distal phalanx of the middle finger, the ring finger, and the pinky finger.

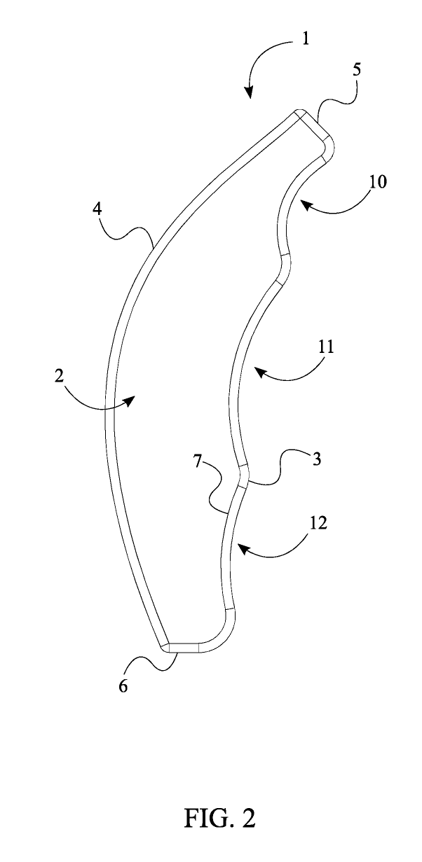

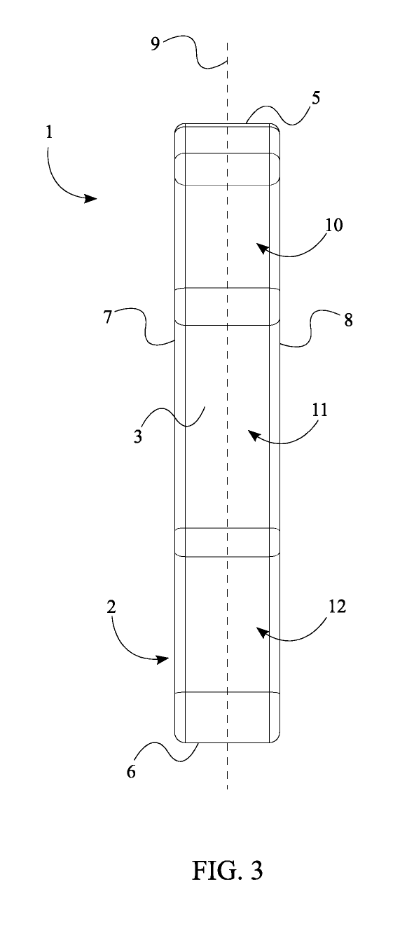

As shown in FIGS. 1-3, the gripping device 1 comprises an elongated structural body 2, an inner surface 3, an outer surface 4, a first lateral surface 7, a second lateral surface 8, a first end 5, and a second end 6. As shown in FIG. 2, the elongated structural body 2 extends from the inner surface 3 to the outer surface 4 and determines an overall width of the gripping device 1. Furthermore, the elongated structural body 2 longitudinally extends from the first end 5 to the second end 6 and determines an overall length of the gripping device 1. The gripping device 1 is tapered from the second end 6 to the first end 5 resulting in the elongated shape. As seen in FIG. 3, the elongated structural body 2 also extends from the first lateral surface 7 to the second lateral surface 8 determining an overall thickness of the gripping device 1. The overall curvature of the elongated structural body 2 is designed to accommodate the distal phalanx of the middle finger, the ring finger, and the pinky finger at the inner surface 3 and be pressed against the palm at the outer surface 4.

As seen in FIG. 2 and FIG. 3, the first distal phalanx-receiving slot 10, the second distal phalanx-receiving slot 11, and the third distal phalanx-receiving slot 12 are positioned along the inner surface 3 and extend from the first lateral surface 7 to the second lateral surface 8. More specifically, the first distal phalanx-receiving slot 10 is positioned adjacent the first end 5. The second distal phalanx-receiving slot 11 is positioned adjacent the first distal phalanx-receiving slot 10 opposite the first end 5. The third distal phalanx-receiving slot 12 is positioned adjacent the second distal phalanx-receiving slot 11 opposite the first distal phalanx-receiving slot 10. The third distal phalanx-receiving slot 12 is also positioned adjacent the second end 6 such that the first distal phalanx-receiving slot 10, the second distal phalanx-receiving slot 11, and the third distal phalanx-receiving slot 12 are distributed from the first end 5 to the second end 6.

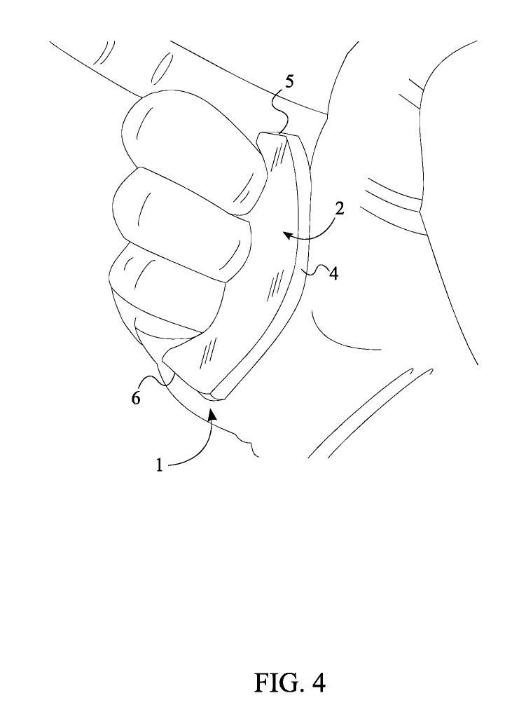

As illustrated in FIG. 4, the present invention is intended to be used when the practitioner is treating a patient utilizing the pistol-grip hand position for thoracic mobilization/manipulation. When the distal phalanx of the middle finger, the ring finger, and the pinky finger are positioned appropriately, the outer surface 4 of the gripping device 1 is pressed against the palm of the user, which then causes passive full flexion of the interphalangeal joints of the middle finger, the ring finger, and the pinky finger. To avoid discomfort, the outer surface 4 is rounded as seen in FIG. 1. Moreover, to accommodate the curvature of the distal phalanx of the middle finger, the ring finger, and the pinky finger, and the curvature of the palm, the elongated structural body 2 is C-shaped. To obtain the overall C-shape, the inner surface 3 is designed to be concave and the outer surface 4 is designed to be convex.

To provide convenience to the practitioner, the present invention is designed to be interchangeable between the left hand and the right hand. As illustrated in FIG. 3, to do so, the present invention comprises a central axis 9 that traverses through and along the elongated structural body 2. For interchangeability, the elongated structural body 2 is symmetrical about the central axis 9. The overall shape of the structural body 2 also allows the user to place the distal phalanx of the pinky finger in the first distal phalanx-receiving slot 10 and place the distal phalanx of the middle finger in the third distal phalanx-receiving slot 12.

The width of the user's fingers can vary from one individual to another. When in use, the pressure applied on the present invention can also vary according to the user. To cater different users, and to absorb varying amounts of pressure, the elongated structural body 2 is manufactured from a semi-flexible material. The materialistic properties allow the present invention to maintain an adequate amount of rigidity while in use and simultaneously allow the distal phalanx of the middle finger, the ring finger, and the pinky finger to be in optimal flexion. To fulfill the intended functionalities, the preferred embodiment of the present invention is made of a semi-flexible material such as, but not limited to, silicone rubber. However, different materials can be used in other embodiments of the present invention as long as the intended functionalities are fulfilled.

Maintaining a firm grip on the present invention is vital when performing thoracic spine manipulation/mobilization procedures. To facilitate the process, the elongated structural body 2 is manufactured from a non-slip material. In another embodiment of the present invention, a non-slip coating can be applied on the elongated structural body 2 so that the practitioner can continue the procedure with no interruptions.

When the present invention is in use, the following process flow is generally followed. The distal phalanx of the middle finger is positioned in the first distal phalanx-receiving slot 10. Next, the distal phalanx of the ring finger is positioned in the second distal phalanx-receiving slot 11. Finally, the distal phalanx of the pinky finger is positioned in the third distal phalanx-receiving slot 12. Next, the outer surface 4 of the gripping device 1 is pressed against the palm of the practitioner, allowing the interphalangeal joints of the middle finger, the ring finger, and the pinky finger to passively flex into a secure position in anticipation of the thoracic mobilization/manipulation. The overall length of the gripping device 1 allows the practitioner to extend the index finger and utilize the pistol-grip hand position to perform a manipulation/mobilization procedure on a patient. Even though the present invention is preferably used with the pistol-grip hand position, the user can also utilize the present invention with other hand positions as well. As an example, the user can position the distal phalanx of the index finger in the first distal phalanx-receiving slot 10. In such instances, the distal phalanx of the middle finger will be positioned in the second distal phalanx-receiving slot 11 and the distal phalanx of the ring finger will be positioned in the third distal phalanx-receiving slot 12. In another instance, the user can utilize a pair of distal phalanx-receiving slots instead of using the first distal phalanx-receiving slot 10, the second distal phalanx-receiving slot 11, and the third distal phalanx-receiving slot 12.

Although the invention has been explained in relation to its preferred embodiment, it is to be understood that many other possible modifications and variations can be made without departing from the spirit and scope of the invention as hereinafter claimed.

What is claimed is:

1. A thoracic spine mobilization/manipulation practitioner support tool comprises:
a gripping device;
a first distal phalanx-receiving slot;
a second distal phalanx-receiving slot;
a third distal phalanx-receiving slot;
the gripping device comprises an elongated structural body, an inner surface, an outer surface, a first lateral surface, a second lateral surface, a first end, and a second end;
the elongated structural body longitudinally extending from the first end to the second end;
the elongated structural body extending from the inner surface to the outer surface;
the elongated structural body extending from the first lateral surface to the second lateral surface;
the first distal phalanx-receiving slot, the second distal phalanx-receiving slot, and the third distal phalanx-receiving slot being positioned along the inner surface from the first lateral surface to the second lateral surface;
the first distal phalanx-receiving slot being positioned along the inner surface adjacent the first end;
the second distal phalanx-receiving being positioned adjacent the first distal phalanx-receiving slot opposite the first end;
the third distal phalanx-receiving slot being positioned adjacent the second distal phalanx-receiving slot opposite the first distal phalanx-receiving slot; and
the third distal phalanx-receiving slot being positioned adjacent the second end.

2. The thoracic spine mobilization/manipulation practitioner support tool as claimed in claim 1 further comprises:
a central axis; and
the central axis traversing through and along the elongated structural body from the first end to the second end.

3. The thoracic spine mobilization/manipulation practitioner support tool as claimed in claim 1, wherein the outer surface is rounded.

4. The thoracic spine mobilization/manipulation practitioner support tool as claimed in claim 1, wherein the elongated structural body is manufactured from a semi-flexible material.

5. The thoracic spine mobilization/manipulation practitioner support tool as claimed in claim 1, wherein the elongated structural body is manufactured from a non-slip material.

6. The thoracic spine mobilization/manipulation practitioner support tool as claimed in claim 1, wherein the elongated structural body is C-shaped.

7. The thoracic spine mobilization/manipulation practitioner support tool as claimed in claim 1, wherein the elongated structural body is manufactured from silicon rubber.

8. A thoracic spine mobilization/manipulation practitioner support tool comprises:
a gripping device;
a first distal phalanx-receiving slot;
a second distal phalanx-receiving slot;
a third distal phalanx-receiving slot;
a central axis;
the gripping device comprises an elongated structural body, an inner surface, an outer surface, a first lateral surface, a second lateral surface, a first end, and a second end;
the elongated structural body longitudinally extending from the first end to the second end;
the elongated structural body extending from the inner surface to the outer surface;
the elongated structural body extending from the first lateral surface to the second lateral surface;
the first distal phalanx-receiving slot, the second distal phalanx-receiving slot, and the third distal phalanx-receiving slot being positioned along the inner surface from the first lateral surface to the second lateral surface;
the first distal phalanx-receiving slot being positioned along the inner surface adjacent the first end;
the second distal phalanx-receiving being positioned adjacent the first distal phalanx-receiving slot opposite the first end;
the third distal phalanx-receiving slot being positioned adjacent the second distal phalanx-receiving slot opposite the first distal phalanx-receiving slot;
the third distal phalanx-receiving slot being positioned adjacent the second end; and
the central axis traversing through and along the elongated structural body from the first end to the second end.

9. The thoracic spine mobilization/manipulation practitioner support tool as claimed in claim 8, wherein the outer surface is rounded.

10. The thoracic spine mobilization/manipulation practitioner support tool as claimed in claim 8, wherein the elongated structural body is manufactured from a semi-flexible material.

11. The thoracic spine mobilization/manipulation practitioner support tool as claimed in claim 8, wherein the elongated structural body is manufactured from a non-slip material.

12. The thoracic spine mobilization/manipulation practitioner support tool as claimed in claim 8, wherein the elongated structural body is C-shaped.

13. The thoracic spine mobilization/manipulation practitioner support tool as claimed in claim 8, wherein the elongated structural body is manufactured from silicon rubber.
